(19) United States
(12) Patent Application Publication
(10) Pub. No.: US 2012/0301762 A1
(43) Pub. Date: Nov. 29, 2012

(54) Modular dry cell battery pack

(75) Inventors: Brian Hart Welker, Pfafftown, NC (US); Gregory Scott Isaacs, Mt. Airy, NC (US)

(73) Assignee: IMAGEWORKS DISPLAY AND MARKETING GROUP

(21) Appl. No.: 13/068,973

(22) Filed: May 25, 2011

(51) Int. Cl. H01M 2/10

(52) U.S. Cl. 429/99

(57) ABSTRACT

A battery pack or receptacle includes a battery housing having end to end battery compartments. Contacts are located at each end and between battery compartments so electrical continuity is possible only if the batteries are properly oriented. Contacts can be wired so that the batteries are wired in series and the batteries in different housings can be wired in parallel so that multiple battery receptacles can be ganged to provide prescribed DC voltage levels and amperage levels for many different applications. The battery receptacles and its components thus form a modular assembly suitable for use in electronic point of sale displays and in other applications where stand alone, portable or field assembled devices would be employed.

### BACKGROUND OF THE INVENTION

1. Field of the Invention

This invention relates to battery receptacles or battery packs that can be used with batteries, especially dry cell batteries. More specifically this invention relates to a modular battery pack that can be reconfigured, using the same components, to connect dry cell batteries in series and parallel, in different arrangements, to provide a DC voltage and/or amperage suitable for almost any desired application.

2. Description of the Prior Art

Battery packs or receptacles are employed in a number of configurations for use with stand alone or portable devices requiring a DC power supply. For devices suited for mass production, batteries are normally inserted into the body of the device. For other applications, a separate battery pack is employed and a cable is used to connect the battery pack to the device. Normally these battery packs employ four batteries, and they are typically arranged to receive the batteries either in side by side configuration or in two rows of two batteries each. However, this arrangement is not suited for ganging multiple battery packs when more than four batteries are required for a specific device.

Although not as common, batteries can also be aligned end to end. No matter what configuration is employed to position the batteries in a battery receptacle housing, it is still desirable to provide an arrangement in which the user cannot incorrectly position batteries so that proper polarity is not maintained. There have been suggestions to use contact arrangements between batteries in which electrical continuity will not be established unless the batteries are inserted in the proper orientation.

U.S. Pat. No. 6,238,818 discloses a housing in which two or more dry cell batteries are positioned end to end so that the batteries in the housing can be inserted into appliances that use dry cells, such as flashlights. The shape of the housing will conform to cylindrical appliance cavities in which dry cell batteries to be inserted. One purpose of this housing is to insure that the polarity of all of the dry cell batteries is properly aligned. The housing has intermediate walls between positions in which individual dry cells are positioned, and contacts are mounted on these intermediate walls. On one side of the wall, the terminal is recessed so that the terminal cannot make contact with the flat negative terminal of a dry cell battery. Therefore if only one of the batteries is not properly inserted, electrical continuity cannot be established between opposite ends of the housing.

U.S. Pat. No. 4,265,984 is another example of a battery housing in which multiple dry cell batteries are aligned end to end. Terminals of opposite polarity are located at the same end of a housing and an elongate conductive element, with a fuse connected thereto, extends from a terminal on a dry cell battery at one end of the housing to the opposite end. Two semi-cylindrical housings are ultrasonically welded or glued together, with the elongate conductive element extending through the housing. The individual dry cells are properly aligned in the housing during manufacture of the housing, so it is not necessary to properly align the dry cell batteries in the field, where improper insertion can be a problem.

U.S. Pat. No. 4,595,641 shows an appliance with a battery compartment in which the positive and negative terminals of four dry cell batteries must all be properly oriented in order to make contact with terminal at opposite end of the battery compartment, and a terminal between the two middle batteries.

### SUMMARY OF THE INVENTION

Prior art battery packs or receptacles are generally dedicated devices in that they are specifically designed for or incorporated into one device. The instant invention is intended to be used with various electrical or electronic devices that can have different voltage and/or amperage requirements. The same modular components are employed, but the batteries can be wired in different ways to provide the operating voltage and amperage required by any number of different device. Therefore, the battery packs of this invention are especially suited for devices that are never intended to be used in the quantities required for efficient mass production and assembly. This battery pack or receptacle is fabricated from modular components that can be wired in different ways to supply different voltage and amperage depending upon the apparatus with which they are to be used. By wiring the receptacle in different ways, the batteries will be combined to supply different voltage and amperage levels. Multiple batteries can be wired in series to provide a voltage in excess of that generated by the individual batteries and different groups of series wired batteries can be wired in parallel to provide greater amperage or current levels.

To provide the different voltage and amperage levels, a battery receptacle in accordance with one aspect of this invention would be used to house multiple dry cell batteries. This battery receptacle would include a housing having a plurality of battery compartments extending end to end between opposite first and second end walls of the housing. Each battery compartment would receive a single dry cell battery, and the intermediate walls would extend between adjacent battery compartments. This battery receptacle would also employ a plurality of contacts. One contact would be mounted in each end wall and in each intermediate wall. Each contact would have a first contact surface, such as an embossment that would engage a positive electrode of a dry cell battery and a second contact surface, such as a spring, that would engage a negative electrode of a dry cell battery. Each contact mounted in an intermediate wall is narrower than the intermediate wall in which the contact is mounted. The intermediate wall has an opening positioned beside the contact mounted therein. A first elongate electrical conductor, typically a wire, would be electrically connected to a contact mounted in the first end wall and would extend through openings in the intermediate walls to the second end wall. A second elongate electrical conductor or wire, would be electrically connected to a contact in the second end wall on an opposite end of the housing from the first end wall, so that dry cell batteries mounted in the battery compartment can be connected in series to an electrical component.

A modular apparatus, in accordance with this invention would be used to mount and connect a sufficient number of batteries to generate a voltage and amperage equal to an operating voltage and amperage for different electrical assemblies with which the modular assembly is used. This modular apparatus would include at least one housing having a plurality of battery compartments with contacts mounted on each end of the housing and between each battery compartment. Each contact includes contact surfaces for engaging positive and negative battery electrodes, to connect batteries, positioned in the battery compartments, in series. Each contact would also include a conductor coupling part where a wire or conductor could be terminated to the contact. A first conductor would be connected to a conductor coupling part of a first contact, and a second conductor would be connected to a conductor coupling part of a second contact so that batteries positioned in battery compartments between the first and second contacts will be connected in series, while multiple modular assemblies can be connected in parallel, so that the operating voltage and amperage for different electrical assemblies can be provided. The contacts are mountable in the housing after being connected to the first and second conductors with the second conductor extending at least partially through multiple battery compartments in the housing. Identical housing components and contacts can be employed with different electrical assemblies having different operating voltage and amperage.

One specific use of a modular battery pack or receptacle in accordance with this invention would be in a retail point of sale device. A method of powering point of sale displays of this type, having electrical components, such as light emitting diodes, audio components and video components, would employ this battery pack assembly including modular components configurable to deliver different output voltages. At least one housing having a plurality of battery compartments would be mounted on the point of sale display. A first contact would be attached or terminated to a first conductor and a second contact to a second conductor. These contacts would be mounted in the housing between each battery compartment. Each contact would include contact surfaces for engaging positive and negative battery electrodes, to connect batteries, positioned in the battery compartments, in series. Each contact would also include a conductor coupling part. The contacts would be positioned with first and second conductors attached thereto so that batteries positioned in battery compartments between the contacts with first and second conductors attached thereto will be connected so that the operating voltage and amperage required for the point of sale display will be provided. Identical housing components and contacts can thus be employed with different electrical components or assemblies having different operating voltages.

### BRIEF DESCRIPTION OF THE DRAWINGS

FIG. 1 is an exploded view of an individual battery receptacle or pack according to this invention that can house up to four batteries aligned end to end.

FIG. 2 is a view of the battery receptacle shown in FIG. 1 with the conductors or leads attached to contacts, which are mounted in battery compartments in a housing.

FIG. 3A-3H are detail views of the battery receptacle shown in FIGS. 1 and 2. FIG. 3A is a top view of the receptacle housing. FIG. 3B is a side view and FIG. 3C is an end view of the battery receptacle. FIG. 3D is a top plan view of the battery receptacle housing showing four in-line battery compartments. FIG. 3E is a partial section view along section lines 3E-3E in FIG. 3D showing the positioning of a diode on the negative conductor or wire. FIG. 3F is a partial section view along section lines 3F-3F in FIG. 3D showing the position of a thermal fuse on the negative conductor or wire. FIG. 3G shows the bottom of the housing including indicia in the individual battery compartments. FIG. 3H shows the exterior of the bottom of the housing.

FIGS. 4A and 4B are three dimensional views of the opposite sides of one of the contacts positioned at both ends of the housing and in intermediate walls separating the battery compartments.

FIG. 5 is an exploded view of the components of four individual battery receptacles that can be ganged together so that more than the four batteries positioned in one battery receptacle can be wired in series and the assembly can be mounted as one piece on a device, such as an electronic point of sale display. Multiple battery receptacles, each containing multiple batteries, can be wired in parallel.

FIG. 6A is a view of the ganged assembly of four battery receptacles, the component of which are shown in FIG. 5, to form two voltage supplies, of 12 VDC each in parallel, can be assembled using 1.5 VDC batteries. FIG. 6B is a partial section view along section lines 6B-6B in FIG. 6A showing a thermal fuse wired in line. FIG. 6C is a partial section view along section lines 6C-6C in FIG. 6A showing a diode wired in line.

FIG. 7 is a three dimensional view of the assembly shown in FIG. 6A.

FIG. 8 is an exploded view of an alternate embodiment in which two rows of four in line battery compartments are formed in a single housing.

FIG. 9 is a three dimensional view of the dual row battery receptacle shown in FIG. 8.

FIG. 10 is a schematic of a point of sale display with which the battery pack of this invention can be employed in multiple assembled versions.

### DETAILED DESCRIPTION OF THE PREFERRED EMBODIMENTS

The modular battery pack or receptacle 2 according to this invention can be configured to wire multiple batteries in different ways so that voltage and amperage supplied by the batteries in battery pack 2 will correspond to the voltage and amperage requirements for the electrical or electronic device with which the battery pack 2 and the batteries are to be used. The same components of battery pack 2 can be employed for electrical and electronic devices having different voltage and amperage requirements. The battery pack or receptacle 2 according to this invention is modular in form and is to be used with a wide variety of electronic or electrical devices that require electrical power from DC batteries. This battery pack 2 is especially suited for use in retail point of display devices that employ electrical components such as LED's, LCD, lamps, audio annunciators or other components. However, this battery pack 2 is not limited to use with such devices.

Not only is this battery pack 2 intended for use in different applications, it is especially suited for use, sometimes alone or sometimes in combination with one or more other identical battery packs 2, for supplying different voltages in different applications. Battery packs 2 can be ganged, and batteries in the battery pack can be wired in series, to deliver the needed voltage, as well as amperage, for a particular situation. For example, three D-cell batteries mounted in a single battery pack 2 can be wired in series to deliver 4.5VDC. Four identical battery packs 2 can be connected so that 16 batteries are mounted therein to provide two 12VDC power supplies wired in parallel to deliver sufficient amperage to a load and to be capable of having a relatively long battery life required for certain situations.

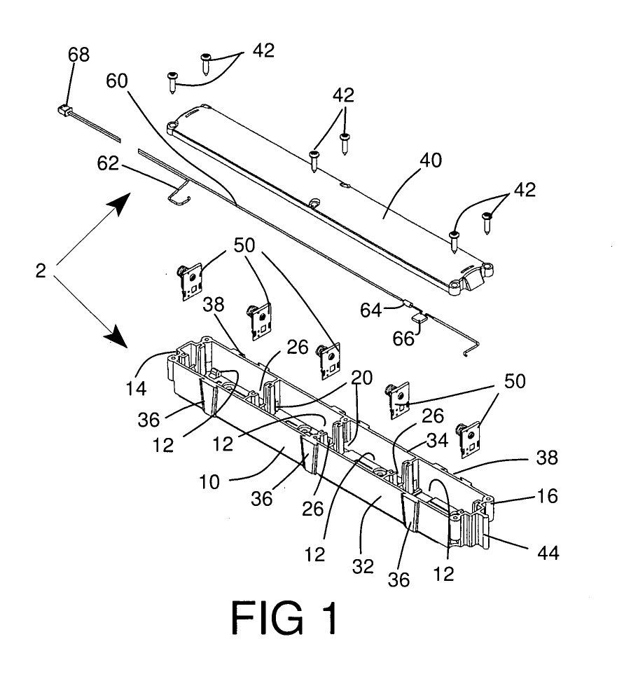

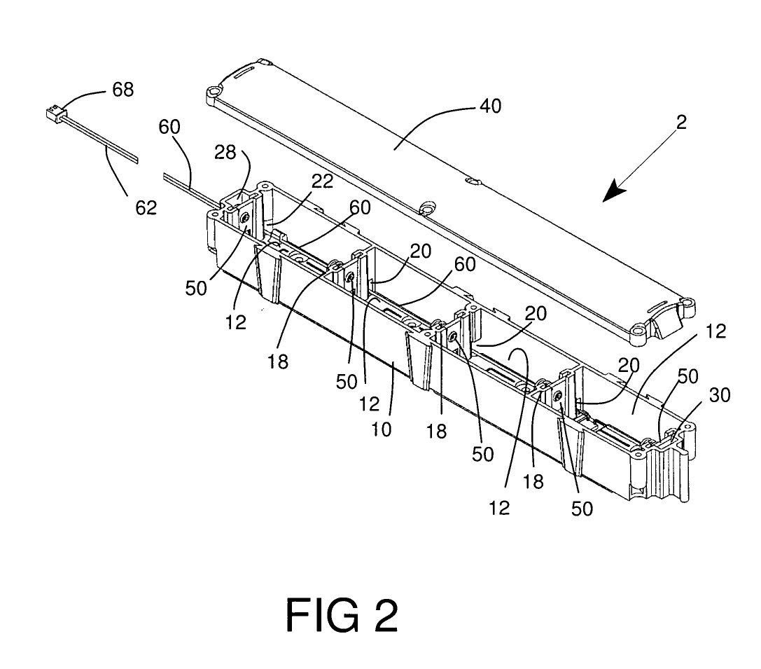

In the preferred embodiment of this invention, each battery pack or receptacle 2 includes a housing 10 with four battery compartments 12. Three contacts 50 are located in intermediate walls 18 to connect the positive electrode of each battery to a negative electrode of an adjacent battery. The same contacts 50 are mounted in a first end wall 14 at one end of the housing 10 and in a second end wall 16 at the opposite end of the housing 10. In the embodiment of FIGS. 1-4, a first conductor 60, preferable in the form of a 22 AWG wire, is connected to a contact 50 at the second end 16, and a second conductor 62 is attached to a contact 50 at a first end 14. The contact 50 at the second end 16 will engage the negative electrode of the battery in the adjacent battery compartment 12. The contact at the first end 14 will engage the positive electrode of the battery in the battery compartment 12 adjacent the first end 14.

Four battery compartments 12 are located in end to end alignment between the first end 14 and the second end 16. Four 1.5 VDC, preferably in the form of conventional D-cell batteries, positioned in these compartments 12 will be connected in series to deliver 6VDC. Each battery compartment is defined by at least one intermediate wall 18 and by a portion of the first and second side walls 32, 34. The battery compartments 12, on the opposite ends of the housing 10, are also formed by the first and second end walls 14 and 16. The two central battery compartments 12 are flanked by intermediate walls 18 on opposite ends of the compartments. A bottom wall 46 extends between opposite end walls 14, 16 and the top of each battery compartment 12 is open so that a single battery can be inserted into each battery compartment in a conventional manner. A cover 40 can be attached to the housing by mounting screws 42 to close the battery compartments 12 after insertion of batteries therein.

In order to permit passage of an elongate conductor or wire 60 from first end 14 to second end 16 and beyond, each of the intermediate walls 18 has an intermediate wall opening 20 located beside the contact 50 mounted in that intermediate wall 18, which is wider than the contact 50. Opening 22 at the base of the first end wall 14 and an opening 24 at the base of the second end wall 16 are aligned with the three openings 20 on one side and adjacent to the base of the intermediate walls 18, so that five aligned openings are formed through the housing 10. This will permit any of the contacts 50 to be connected to any other contact 50 in the same housing by conductor 60, although normally the conductor 60 will only be terminated to one of the contacts 50. Conductor 62 will typically be terminated to another contact 50, so that the batteries between the two terminated contacts 50 will be connected in series.

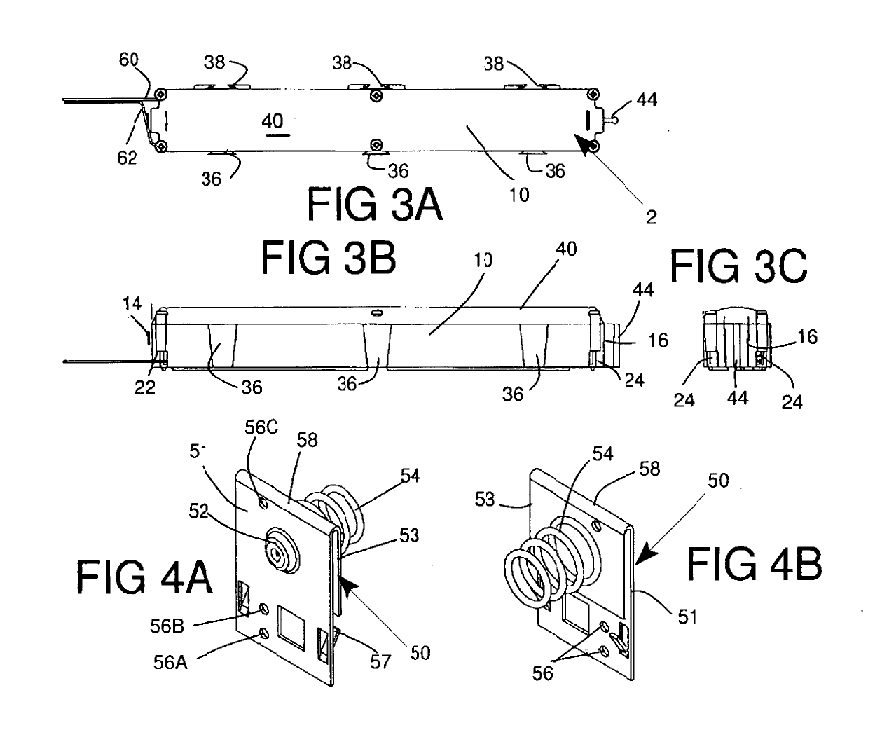

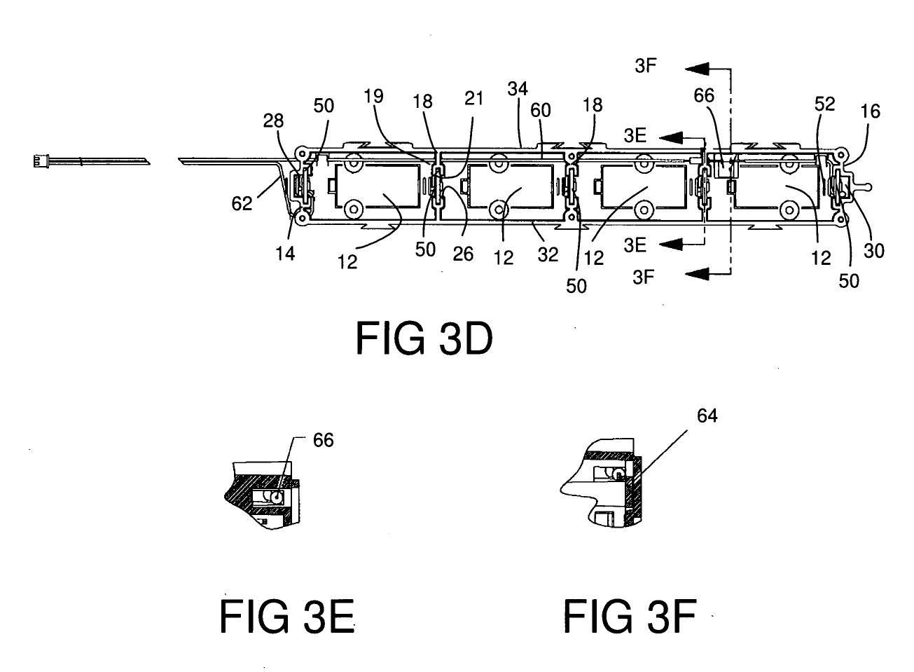

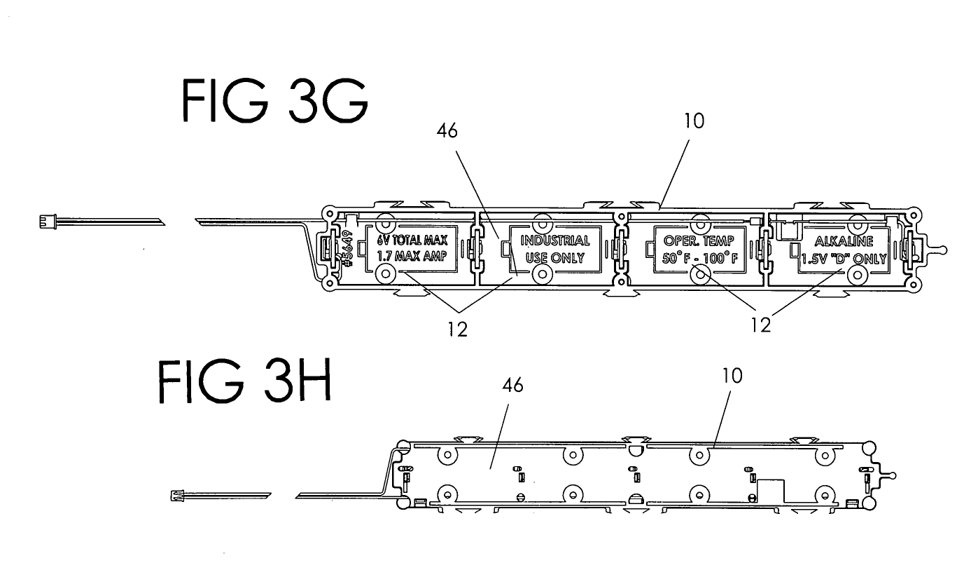

Individual stamped and formed contacts 50 are mounted in each intermediate wall 18 as well as in the first and second end walls 14, 16. The intermediate walls 18 each have a slot 26 extending inwardly from the top of each wall 18. Contacts 50 are inserted into the intermediate wall slots 26 from above. Contacts 50 are also inserted into the first end wall slot 28 and second end wall slot 30. The end wall slots 28 and 30 have a width that is greater than the intermediate wall slots 26. The intermediate wall slots 26 extend from the top of each intermediate wall 18 to the housing bottom wall 46. The intermediate walls 18 can therefore are formed by two separate wall sections on opposite sides of its intermediate wall slot 26. As best seen in FIG. 3D, each intermediate wall section has a wider portion 19 adjacent the intermediate wall slot 26. The thickness of this wider portion 19 is greater than the thickness of the individual contact 50. Grooves 21 on opposite sides of the intermediate wall slot 26 and in the wider portions 19 are wide enough so that the side edges of each contact 50 fit within these grooves to hold the contacts 50 in place. The width of the wider portions 19, relative to the width of the contacts 50, plays a significant role in insuring that the contacts 50 are properly inserted into the housing 10, as will be more apparent after a subsequent discussion of the structure of the contacts themselves.

The greater width of the end wall slots 28, 30, especially the slot 28 in end wall 14, allows insertion of the contacts 50, and the contact spring 54 into the end wall slots 28, 30. The significance of this slot width will also be more apparent after a discussion of the contact geometry.

Each contact 50 comprises a U-shaped stamped and formed member fabricated from an electrically conductive metal. The one piece contact 50 has a first plate 51 joined to a second parallel plate 53 by a bend or curved middle section 58 at the top of the two plates 51, 53. A first contact surface 52 in the form or an embossment or generally conical protrusion extends from the first plate 51. In the preferred embodiment, the size and shape of this embossment 52 allows this contact surface to engage a protruding positive electrode on a standard D-cell, dry cell battery. The second plate 53 includes a second contact surface 54 in the form of a coil spring extending therefrom. In the representative embodiment depicted herein, the spring 54 has a size and shape that will allow it to make electrical contact with a generally flat negative electrode on a standard D-cell, dry cell battery. Of course it should be understood that the contact surfaces 52 and 54 can have a different size and shape for embodiments that are employed with other battery sizes or types.

The first contact plate 51 is taller than the second contact plate 53. In the preferred embodiment depicted herein, three conductor coupling parts in the form of three holes 56A, 56B and 56C are located on the first contact plate 51. Two of these conductor coupling holes 56A and 56B are located near the protruding lower edge of the first contact plate, and the third conductor coupling hole 56C is located near the bend 58 at the upper end of the contact plate. Wires can be inserted through these holes 56A, 56B and 56C to couple or electrically connect the wire to the contact 50. In the preferred embodiment, the striped end of a 22 AWG wire can be inserted through any of these holes and soldered to the contact 50. Two holes or coupling parts 56A and 56B are provided so that two wires, one of which may be a jumper wire, can be electrically connected to the same contact 50, as will be subsequently discussed in more detail. It should be understood that other coupling configurations can be employed with these contacts. For example, solderless connections, such as crimped or insulation displacement contacts can be substituted for the solder connection employed in this representative embodiment. A resilient male contact can also be crimped to the wire and inserted into engagement with a coupling part, which can have the same configuration as the holes 56A, 56B or 56C. The contacts 50 can also be plated in a conventional manner.

Each contact 50 will be inserted in one of the slots 26, 28 or 30. A wire or wires can be terminated to each contact 50 before the contact is inserted into its appropriate housing or housing wall slot or after the contact 50 is positioned in the appropriate slot. Retention tabs 57 are struck from the lower edge of the first plate 51, and these retention tabs will engage the interior sides of the intermediate wall along the grooves 21 to secure the contact 50 into an intermediate wall 18.

The configuration of the contacts 50 and the intermediate wall slots 26 insure that the batteries can only be inserted into the battery compartments 12 in the proper orientation if there is to be continuity between the batteries. The relatively wider yoke 19 on the intermediate walls 18 is located adjacent slots 26 and yoke 19 is wider than other portions of the intermediate walls 18 so that the yoke 19 extends beyond the embossment 52 on the contact 50 positioned in the intermediate wall slot 26. In other words the contact embossment 52 is recessed relative to the insulating intermediate wall 18. If a battery is inserted into a battery compartment 12, with the generally flat negative electrode positioned adjacent to a contact embossment 52, there will be a gap between the battery electrode and the contact surface formed by the contact embossment 52. Thus there will be a open condition in which current will not flow and in which the batteries will not be connected in series. There will then be no potential difference between the conductors 60 and 62 at the output connector 68 attached thereto. Thus one improperly oriented battery means that the batteries will not drain. If a battery is properly positioned in its battery compartment 12, the protruding positive battery electrode will extend into the gap formed by the intermediate wall slot 26 for a sufficient distance to engage the embossment 52 forming the first contact surface. With all of the batteries properly aligned, a potential difference will be present across the contacts in the electrical connector 58.

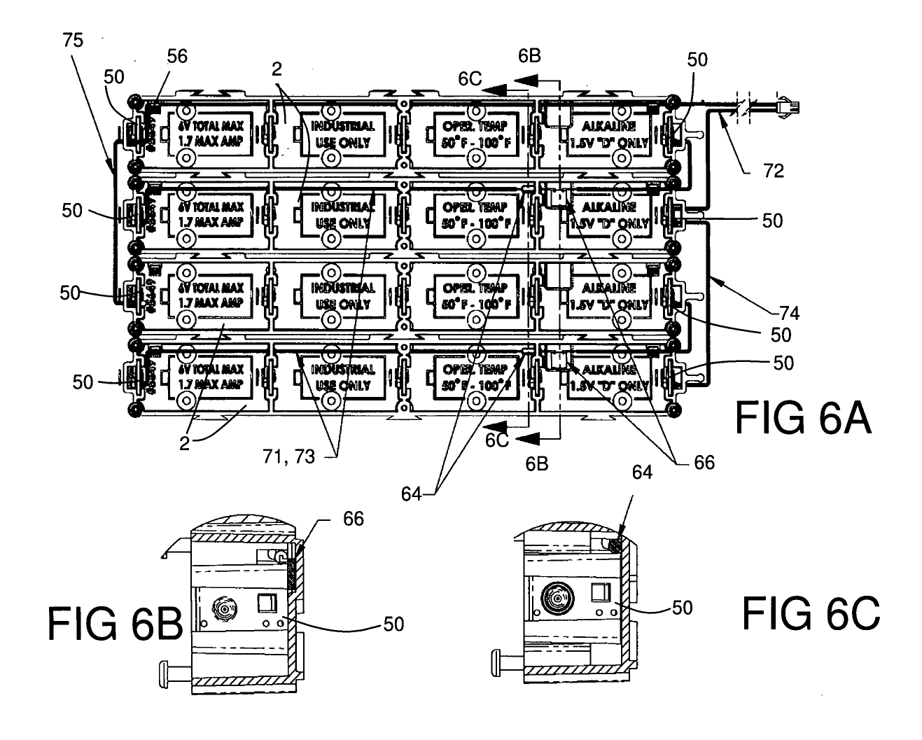

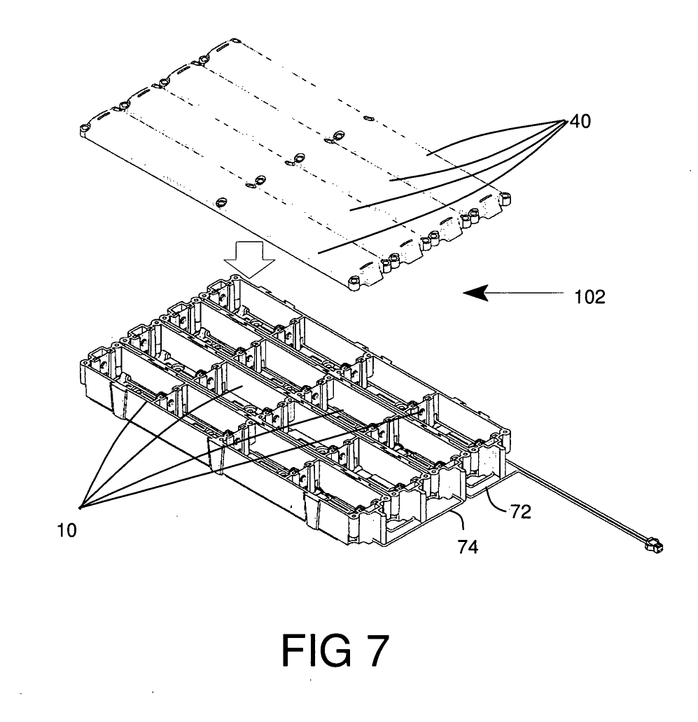

An important feature of the battery receptacle or pack 2 according to this invention is that the housing 10 and the contacts 50 can be assembled with wires that have been cut to length to fabricate different assemblies that provide different voltage levels. In other words the receptacle 2 is modular and can be employed as a single component or multiple battery receptacles can be ganged for voltage levels that are greater than the sum of the voltages of batteries that can be inserted into a single battery housing 10. The manner in which different voltages can be delivered will be apparent by comparing the configuration shown in FIG. 3D with the ganged arrangement of FIG. 6A.

FIG. 3D shows how a single battery receptacle 12 can be wired and assembled to deliver 6VDC using four 1.5 VDC batteries wired in series. The proper orientation of four batteries is shown by the figure of a battery that is seen at the bottom of each battery compartment 12. Four batteries should therefore be aligned end to end with the positive electrode of each battery facing to the left in FIG. 3D, so that it can engage the embossment forming the first contact surface on each of the contacts 50 positioned either in the intermediate walls 18 or in the first and second end walls 14 and 16. The contact 50 located in the slot in the first end wall 14 will comprise a positive terminal, since it is wired directly to wire or conductor 62. The rightmost contact 50 mounted in the second end wall 16 will comprise a negative terminal, which is wired directly to negative conductor or wire 60. To terminate the wire 62 to the leftmost contact, the wire 62 is first inserted through a hole in the bottom wall adjacent the first end wall 28 into the leftmost housing compartment 12 in FIG. 3D. The stripped end of wire 62 is then inserted though one of the contact holes 56A or 56B forming the conductor coupling part for this contact. The stripped end of the wire is soldered to this contact 50, which is then inserted from above into the first end wall slot 28. The conductor coupling hole 56C at the top of the contact 50 is positioned to be accessible so that a wire can be terminated to the contact 50 after it has been inserted into any one of the walls. To terminate the negative wire 60 to the rightmost contact 50, wire 60 is inserted through the aligned end wall openings 22, 24 and intermediate wall openings 20 until the wire 60 extends through both ends of the housing 10. The right end of wire 60, as seen in FIG. 3D is then inserted back through an opening in the bottom wall 46, as seen in FIG. 3H, and the stripped wire end is soldered to the rightmost contact 50. Then the rightmost contact 50 is inserted into second end wall slot 30. The contacts 50 positioned in the intermediate walls 18 are not directly connected, but will be connected through batteries inserted into the receptacle compartments 12. The diode 64 will prevent current flow in the wrong direction and the thermal fuse 66 will open the circuit in the event of overheating. When four batteries are connected in this manner, 6VDC will be present across the terminals of output connector 68 at the ends of conductors 60 and 62.

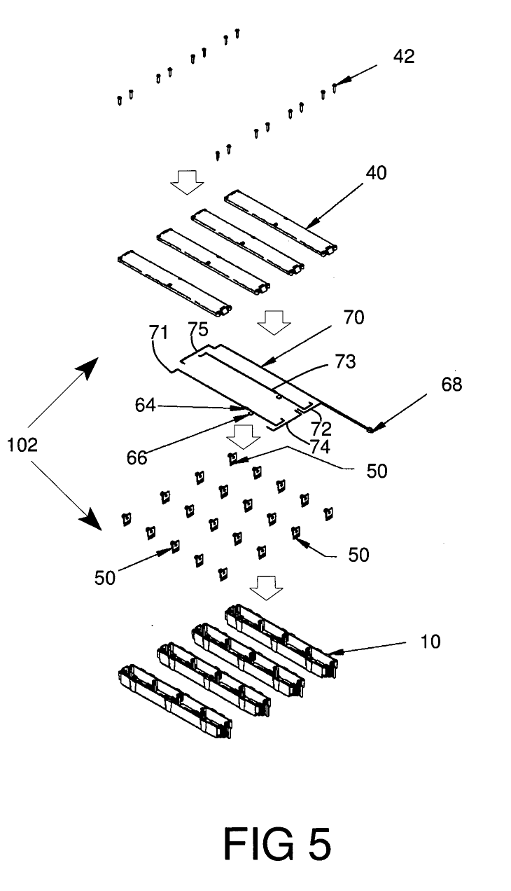

FIG. 6A is a view of an arrangement in which four battery receptacles 2 are positioned side by side and wired to provide two 12VDC power supplies wired in parallel to form a battery receptacle assembly 102 including the components of FIG. 5. The four housings 10 and the contacts 50 are the same as those used in the 6VDC configuration shown in FIG. 3D. The manner in which the contacts 50 and therefore the batteries are wired differs however. In this configuration, the eight batteries in the top two receptacles are wired in series. The eight batteries in the bottom two receptacles are also wired in series, and the two eight battery groups are wired in parallel. A positive wire 70 extends through the housing 10 of the top receptacle and is terminated to the top leftmost contact 50. A jumper wire 75 extends from the top leftmost contact 50 to the leftmost contact 50 in the third battery receptacle 2. Thus two wires are terminated to the leftmost contact 50. As seen in FIGS. 4A and 4B each contact 50 has two conductor coupling parts 56A and 56B in the form of two openings for receiving the stripped end of two wires to be soldered to the same contact 50. The negative wire 72 in the top pair of housing receptacles is terminated to the contact 50 at the right of the second row of receptacles 2. A jumper wire 71 extends from the negative contact 50 in the top receptacle 2 to the positive contact 50 in the second row so that eight batteries are wired in series. A jumper wire 74 connects the negative contacts 50 in the second and fourth receptacles 2. A jumper wire 73 serves the same function in the bottom pair of receptacles 2 as the upper jumper 71, so that two 12VDC power supplies are wired in parallel.

Since each of the receptacles 2 are configured to accept four batteries aligned end to end, two or more battery receptacle housings 10 can be positioned side by side when multiple receptacles 2 are ganged. One side wall 32 has a series of protruding male profiles 36 and the other side wall 34 has a series of cooperating female profiles 38. The male profiles 36 can be inserted into the female profiles 38 to secure adjacent housings together. A solvent weld of these male and female or dovetail profiles can be formed to insure that the individual housings are held together and the array can be handled as a single part. Handles 44 at one end, serve not only to help manipulate the receptacles 2 to assemble them to a device, but also provide a readily observable indication of polarity. FIG. 6A also demonstrates that information material may be provided on the inside of the receptacle compartments 12, although the invention is not limited by the representative informational material shown for one representative embodiment employing standard 1.5 VDC D-cell batteries.

Although more that four batteries can be connected in series by ganging multiple receptacles 2, it should be understood that the same components can be employed if fewer than four batteries need to be connected in series. For example, if a 4.5 VDC supply is required, three 1.5 VDC batteries can be connected in series in one battery receptacle or battery pack 2. All of the contacts 50 are identical and each can be terminated to a wire. Thus instead of terminating wire 60 in FIG. 3D to the rightmost contact positioned in the end wall 16, the wire 60 could be terminated to the contact 50 in the third intermediate wall 18, the closest intermediate wall to end wall 16. When wired in this manner, three 1.5 VDC batteries could be inserted into the three leftmost receptacles 12 to provide a 4.5 VDC power supply.

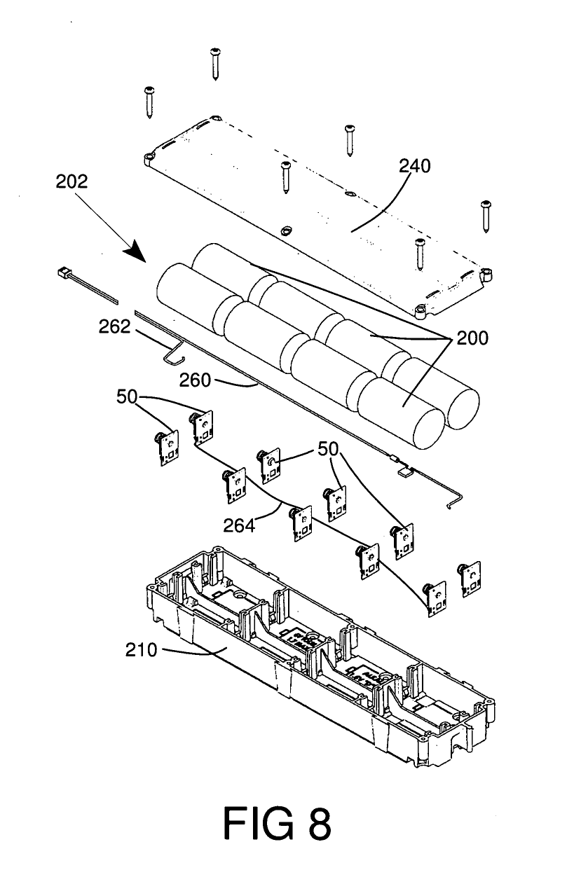

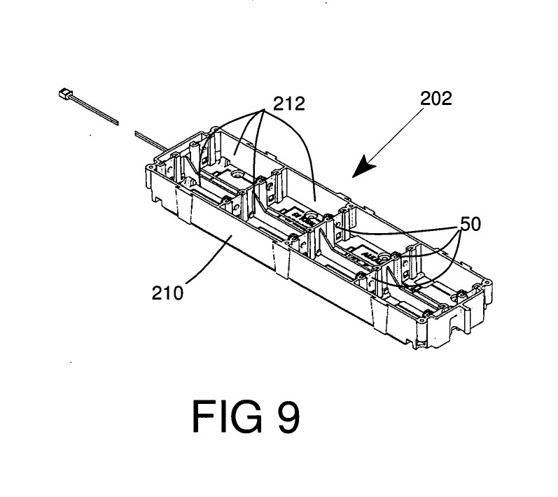

The preferred embodiment of this invention may employ a housing 10 in which all of the batteries will be inserted in end to end alignment. However, it should be understood that alternate embodiments are also possible. For example, the alternate embodiment of a battery receptacle 202, shown in FIGS. 8 and 9, comprises a housing 210 with two side by side rows of batteries 200. The same contacts 50 are employed in this configuration. The conductors 260, 262 and 264 are terminated to the contacts so that the eight batteries 200 can be connected in series to form a 12VDC power supply. Conductors 260 and 262 would then be connected in the same manner as conductors 70 and 71 in FIG. 6A. It should be noted, however, that this housing 210 need not be fully populated. For example, only a single row could be filled with batteries and the conductors can be terminated to contacts in the same general manner as shown in FIG. 3D.

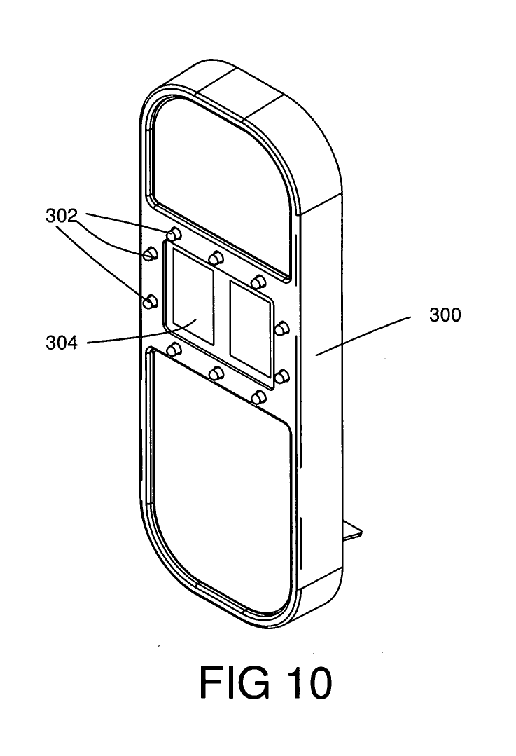

Although battery receptacles or battery packs employing the principles of this invention can be employed in any number of applications, one typical application is shown with reference to a retail point of sale device 300 shown in FIG. 10. This electronic device employs a series of LEDs 302 and a two digit electronic numeric display 304. Both of these components may require only 3VDC. A sufficient power supply might then be provided by populating a battery receptacle 2 with only three 1.5 VDC dry cell batteries to provide 4.5 VDC, which would provide a sufficient margin to operate such a device for a suitable amount of time. If however a display 304 requiring a larger voltage were employed, multiple battery receptacles could be employed to deliver appropriate DC voltage to each component. For example, audio or video components might be employed that would require a larger DC voltage. As described with respect to FIG. 6A, batteries can be wired in parallel to increase the current and the life of a device in which the drain or the number of cycles would be large. Almost any DC voltage could be provided by simply wiring battery contacts in the previously described manner to connect batteries positioned in ganged battery receptacles or battery packs. In practice the battery compartments could be configured and wired so that they would produce the maximum voltage and amperage that would be required by an electrical apparatus, which presumably could include a number of components. This modular battery pack would therefore be especially suited for use with electronic devices that would not be manufactured in volumes sufficient for mass production, but which are still cost sensitive. Furthermore, this modular battery pack would be well suited for field assembly of electronic or electrical components that may need to be modified for particular situations. The representative embodiments depicted herein are intended for use with D-cell batteries, generally the most widely used. However, it should be understood that they could be used with other types of batteries, including standard AA, AAA, and C dry cell batteries, as well as most, and possible all types of standard dry cell batteries. New or nonstandard batteries could also be combined using the battery receptacle according to this invention. Therefore it should be understood that the embodiments depicted herein are merely representative of the manner in which this invention can be employed, and the scope of this invention is not limited to the particular embodiments depicted herein.

We claim:

1. A battery receptacle for use with dry cell batteries, the battery receptacle comprising:
a housing having a plurality of battery compartments extending end to end between opposite first and second end walls of the housing, each battery compartment being configured to receive a single dry cell battery, the housing including intermediate walls extending between adjacent battery compartments;
a plurality of contacts, one contact being mounted in each end wall and in each intermediate wall, each contact having a first contact surface engagable with a positive electrode of a dry cell battery and a second contact surface engagable with a negative electrode of a dry cell battery;
wherein each contact mounted in an intermediate wall is narrower than the intermediate wall in which the contact is mounted, the intermediate wall having an opening positioned beside the contact mounted therein; and
a first elongate electrical conductor electrically connected to a contact mounted in the first end wall and extending through openings in the intermediate walls to the second end wall, and a second elongate electrical conductor electrically connected to a contact in the second end wall on an opposite end of the housing from the first end wall, so that dry cell batteries mounted in the battery compartment can be connected in series to an electrical component.

2. The battery receptacle of claim 1 wherein the battery compartments are configured to receive a D-cell battery.

3. The battery receptacle of claim 1 wherein a diode is connected to the first elongate electrical conductor.

4. The battery receptacle of claim 3 wherein a fuse is connected to the first elongate electrical conductor.

5. The battery receptacle of claim 1 wherein the contacts comprise U-shaped members insertable into slots in the end walls and the intermediate walls.

6. The battery receptacle of claim 1 wherein the first contact surface of each contact has an embossment engagable with a positive electrode of a dry cell battery and the second contact surface of each contact has a spring engagable with a negative electrode of a dry cell battery.

7. The battery receptacle of claim 1 wherein the housing has parallel side walls extending between first and second end walls with the intermediate walls being perpendicular to the side walls to form rectangular battery compartments extending end to end between the first and second end walls.

8. The battery receptacle of claim 1 wherein the housing includes side walls, one side wall including a male profile and the other side wall including a female profile so that multiple battery receptacles can be ganged side by side with male profile engaging female profiles on adjacent housings.

9. The battery receptacle of claim 1 wherein two rows of battery compartments extend side by side between first and second ends of the housing.

10. The battery receptacle of claim 1 wherein each contact includes a wire coupling part, but the first and second elongate conductors are not terminated to wire coupling part on each contact.

11. A modular apparatus for use in mounting and connecting a sufficient number of batteries to generate voltages and amperages equal to operating voltage and amperage for different electrical assemblies with which the modular apparatus is used, the modular apparatus comprising:
at least one housing having a plurality of battery compartments;
contacts, mounted on each end of the housing and between each battery compartment, each contact including contact surfaces for engaging positive and negative battery electrodes, to connect batteries, positioned in the battery compartments, in series, each contact also including a conductor coupling part;
a first conductor connectable to a conductor coupling part of a first contact, and a second conductor connectable to a conductor coupling part of a second contact so that batteries positioned in battery compartments between the first and second contacts will be connected so that the operating voltage for different electrical assemblies can be developed;
whereby identical housing components and contacts can be employed with different components having different operating voltages.

12. The modular apparatus of claim 11 wherein the housing includes male and female profiles on opposite sides of the housing so that multiple housings can be mounted side by side for use in supplying component voltages greater than the sum of output voltages of batteries positionable in one housing.

13. The modular apparatus of claim 11 including openings in exterior walls of the housing so that conductors can connect batteries positionable in two adjacent housings.

14. The modular apparatus of claim 11 wherein each individual battery compartment is configured to receive an individual D-cell battery.

15. The modular apparatus of claim 11 wherein the contacts are insertable into slots in battery compartment walls after being coupled to a wire comprising one of the conductors.

16. The modular apparatus of claim 11 wherein the battery compartments are arranged in end to end alignment in each housing.

17. The modular apparatus of claim 11 wherein one of the conductors extends between opposite ends of the housing.

18. The modular apparatus of claim 11 including at least one intermediate conductor wire for connecting batteries, when positioned in battery compartments in separate housings in parallel.

19. A method of powering point of sale displays having at least one electrical component selected from the group of light emitting diodes, audio components and video components, and a battery pack assembly suitable for combining dry cell batteries in a configuration to supply prescribed voltage and amperage to the selected electrical component, the battery pack further comprising modular components configurable to deliver different output voltages, the method comprising the steps of:
mounting at least one housing having a plurality of battery compartments to the point of sale display;
attaching a first contact to a first conductor and a second contact to a second conductor and mounting the contacts in the housing mounting contacts between each battery compartment, each contact including contact surfaces for engaging positive and negative battery electrodes, to connect batteries, positioned in the battery compartments, in series, each contact also including a conductor coupling part;
positioning the contacts with first and second conductors attached thereto so that batteries positioned in battery compartments between the contacts with first and second conductors attached thereto will be connected in series so that the operating voltage is equal to the sum of the batteries between the first and second contacts;
whereby identical housing components and contacts can be employed with different components having different operating voltages.

20. The method of claim 19 including the step of inserting D-cell batteries in the battery compartments, so that power in multiples of 1.5 volts is supplied to the point of sale display depending upon the operating voltage of the electrical components mounted employed on the point of sale display.
